(19) United States
(12) Patent Application Publication
(10) Pub. No.: US 2021/0039961 A1
(43) Pub. Date: Feb. 11, 2021

(54) FILTER DEVICE FOR CLEANING COOLANT WATER FOR AN INTERNAL COMBUSTION ENGINE

(71) Applicant: Mahle International GmbH, Stuttgart (DE)

(72) Inventors: Sebastian Barthelmes, Plochingen (DE); Eva Boendel, Stuttgart (DE); Anna Eichner, Grunbach (DE); Hendrik Frank, Schwieberdingen (DE); Matthias Gaenswein, Esslingen (DE); Martin Hein, Stuttgart (DE)

(21) Appl. No.: 16/982,403

(22) PCT Filed: Mar. 14, 2019
(86) PCT No.: PCT/EP2019/056430

§ 371 Date: Sep. 18, 2020

(30) Foreign Application Priority Data
Mar. 20, 2018 (DE) 10 2018 204 265.9

(51) Int. Cl. C02F 1/00; C02F 1/28; C02F 1/42

(52) U.S. Cl. CPC C02F 1/001; C02F 1/283; C02F 2103/023; C02F 2001/427; C02F 1/42

(57) ABSTRACT

The present disclosure describes a filter device, e.g., a filter cartridge, for cleaning coolant water for an internal combustion engine. The filter device includes a filter housing defining a housing interior space through which coolant water can flow. An untreated water inlet and a clean water outlet are arranged in the filter housing. A water-permeable separating device divides the housing interior space into a first filtration zone and into a second filtration zone. A first packing material containing activated charcoal for removing dirt particles from the coolant water is present in the first filtration zone, and a second packing material containing hydronium cations and hydroxide anions for demineralizing the coolant water is present in the second filtration zone.

### CROSS-REFERENCE TO RELATED APPLICATION

This application claims priority to International Patent Application No. PCT/EP2019/056430 filed Mar. 14, 2019, which claims priority to German Patent Application No. DE 10 2018 204 265.9 filed Mar. 20, 2018, the contents of each of which is hereby incorporated by reference in its entirety.

### TECHNICAL FIELD

The invention relates to a filter device, in particular a filter cartridge, for cleaning coolant water for an internal combustion engine, as well as an internal combustion engine comprising a filter device of this type.

### BACKGROUND

In modern internal combustion engines, the combustion chambers are increasingly cooled by means of active injection of coolant water. A system of this type is known, for example, from U.S. Pat. No. 8,875,666 B2. By means of the reduction of the temperature in the combustion chambers effected by means of the water cooling, less nitrogen oxide is created during the combustion process than in the case of systems without a water cooling of this type, in the case of which the temperature is thus higher in the combustion chambers.

To prevent unwanted contaminations or deposits of dirt particles in the combustion chamber, it is required that the used coolant water meets high cleaning requirements. This is usually ensured by means of a multi-stage filtration of the coolant water before the latter is introduced into the combustion chamber.

For example drinking water, tap water, condensation water, or collected rain water can be used as coolant water, which is to be cleaned.

### SUMMARY

It is an object of the present invention to show new ways in the development of filter devices for cleaning coolant water for an internal combustion engine.

This object is solved by means of the subject matter of the independent claim(s). Preferred embodiments are subject matter of the dependent claims.

It is thus the basic idea of the invention to construct a filter device for cleaning coolant water for an internal combustion engine in a 2-stage manner, wherein a first packing material is arranged in a first filtration zone, and a second packing material is arranged in a second filtration zone. Said first packing material serves to remove particulate contaminations and organic components from the coolant water. According to the invention, activated charcoal is used for this purpose, at which said organic components or dirt particles, respectively, can accumulate due to adsorption.

In addition, the activated charcoal packing material is to reduce oxidizing disinfectants, which may be present in the water, e.g. chlorine, hypo chloride, chlorine dioxide, and other, because these oxidizing agents could degrade and thus irreversibly damage an ion exchanger, which is connected downstream.

According to the invention, the second packing material, which is present in the second filtration zone, contains hydronium cations and hydroxide anions, by means of which the coolant water can be mostly or even completely deionized. The second packing material thus forms a so-called ion exchanger. It is ensured in this way that after the introduction of the coolant water into the combustion chambers, no solid particles, for example in the form of salts, can precipitate in said combustion chambers at the chamber walls of the combustion chamber. The use of said ion exchangers in the hydronium and hydroxide form instead of the salt forms used from conventional ion exchangers, mostly in the form of sodium and chloride, is essential for the invention in the case of the filter device presented herein. In contrast to conventional ion exchangers of this type in salt form, it can thus be ensured in the case of the filter device presented here that no salt, but only water is formed or released, respectively, in response to the ion exchange. The above-mentioned contaminations in the combustion chamber and problems associated therewith in response to the combustion process can thus be avoided.

As a result, high purity, demineralized coolant water for cooling the combustion chamber of internal combustion engines can thus be created by means of the filter device presented here.

A filter device according to the invention, which can preferably be realized as filter cartridge, serves for cleaning coolant water for an internal combustion engine. For this purpose, the filter device comprises a filter housing, which is delimited by a housing interior space, through which coolant water can flow and in which an untreated water inlet and a clean water outlet are arranged. The filter device further comprises a water-permeable separating device, which divides the housing interior space into a first filtration zone and into a second filtration zone. A first packing material containing activated charcoal for removing dirt particles from the coolant water is arranged in the first filtration zone. A second packing material containing hydronium cations (H⁺) and hydroxide (OH⁻) anions for demineralizing the coolant water is arranged in the second filtration zone.

The hydronium cations (H⁺) are bound to an organic matrix comprising covalently bound sulfonate anions, thus to a highly acidic cation exchanger, as exchangeable ions. The hydroxide anions (OH⁻) are bound to an organic matrix comprising covalently bound quaternary ammonium cations, thus to a highly basic anion exchanger, as exchangeable ions. This ion exchanger thus forms the second packing here.

According to a preferred embodiment, the separating device comprises or is a water-permeable non-woven material, which is impermeable for the first as well as second packing material. It is thus ensured that the first packing material remains in the first filtration zone and that the second packing material remains in the second filtration zone, i.e. that an unwanted mixing of the two packing materials is ruled out. The non-woven material can preferably consist of a plastic material. The production costs for the separating device can be kept low in this way.

According to another preferred embodiment, a biasing means, which biases the second packing material towards the separating device, is provided in the housing interior space. Unwanted relative movements of the second packing material as well as relative movements due to volume changes of the second packing material can be largely or even completely avoided in this way by means of ion exchange with respect to the filter housing and abrasion effects associated therewith.

According to an advantageous further development, the separating device is adjustably attached to the filter housing. The biasing means can thus bias the first packing material by means of the second packing material and also by means of the separating device against an inlet-side housing wall of the filter housing located opposite the biasing means. Unwanted relative movements of the first packing material with respect to the filter housing and abrasion effects associated therewith can also be largely or even completely avoided in this way.

Advantageously, said inlet-side housing wall partially delimits the first filtration zone.

Advantageously, the clean water outlet can be arranged in an outlet-side housing wall of the filter housing, which is located opposite the inlet-side housing wall and which at least partially delimits the second filtration zone. This design makes it possible that coolant water can flow axially through the two filtration zones, whereby a particularly good cleaning effect can be achieved.

Particularly preferably, the biasing means is arranged in the housing interior space between the clean water outlet and the separating device, preferably in the second filtration zone. This variation requires particularly little installation space. It is moreover ensured that not only the second packing material, but—if the separating device or the non-woven material, respectively, is formed to be axially adjustable—the first packing material can also be biased towards the inlet-side housing wall.

According to an advantageous further development, the biasing means comprises at least one spring-elastic element, at which a non-woven material or filter paper is arranged, which is water-permeable and impermeable for the second packing material, and which divides the second filtration zone into an untreated side and a clean side. The biasing force created by the biasing means can be provided in a simple manner by means of a spring-elastic element of this type.

According to a further advantageous further development, the non-woven material, or the filter paper, respectively, is arranged on a mechanically stiff support structure. It is ensured in this way that the flexibly formed non-woven material or the flexibly formed filter paper, respectively, is equipped with the required stiffness. Advantageously, the support structure can thereby be formed in a mesh-like manner. It is ensured thereby that the coolant water can flow through the support structure without any problems.

Particularly preferably, the spring-elastic element comprises or is at least a compression spring, which is in each case supported on the outlet-side housing wall at one end and on the support structure at the other end. Compression springs of this type can be commercially obtained in various embodiment variations and in large quantities and are thus cost-efficient.

According to another preferred embodiment, the filter housing comprises a circumferential wall, which connects the inlet-side housing wall to the outlet-side housing wall. In the case of this embodiment, the filter housing has an antibacterial coating on the inside at least in the area of the circumferential wall. Unwanted microbial activities (fouling), which could interfere with the proper operation of the filter device, are prevented by means of an antibacterial coating of this type.

According to an advantageous further development, the antibacterial coating provided on the filter housing comprises a polymer, which is equipped with an antibacterial material. Biofouling in the long-term use of the filter device is avoided or at least significantly reduced by means of the polymer, which is equipped to be antibacterial in this way.

According to an advantageous further development, the non-woven material of the separating device has an antibacterial coating. The separating device can thus also be used to counteract unwanted microbial activities (biofouling) in the filter device.

In the case of a further preferred embodiment, the antibacterial coating of the separating device comprises silver as coating material. However, other suitable substances, in particular further metals, metal salts, organic monomers, oligomers, and polymers comprising antibacterial properties can also be used. These substances do not mandatorily have to be tolerable for humans, because they are used in the filter device and are not used for the treatment of drinking water according to the drinking water ordinance, which is in effect.

According to another preferred embodiment, the material of the filter housing can comprise or be a granulate, which is equipped to be antibacterial, in particular in the area of the circumferential wall, but also in the area of the two front-side housing walls. The filter housing can thus also be used to counteract unwanted microbial activities in the filter device. Thermally stable antibacterial material, which is suitable for extrusion, such as, for instance, a mixture of PA66 and zinc pyrithione or a corresponding mixture of PA66 and quaternary tetra-alkyl/aryl ammonium compounds, can preferably be used as suitable granulate.

The invention further relates to an internal combustion engine, which comprises at least one cylinder, which has a combustion chamber. The internal combustion engine furthermore comprises an above-presented filter device for cooling the combustion chambers. The above-described advantages of the filter device can thus also be transferred to the internal combustion engine according to the invention.

Further important features and advantages of the invention follow from the subclaims, from the drawing, and from the corresponding figure description on the basis of the drawing.

Preferred exemplary embodiments of the invention are illustrated in the drawing and will be described in more detail in the following description.

### BRIEF DESCRIPTION OF THE DRAWINGS

FIG. 1 illustrates an exemplary filter device according to the present disclosure.

### DETAILED DESCRIPTION

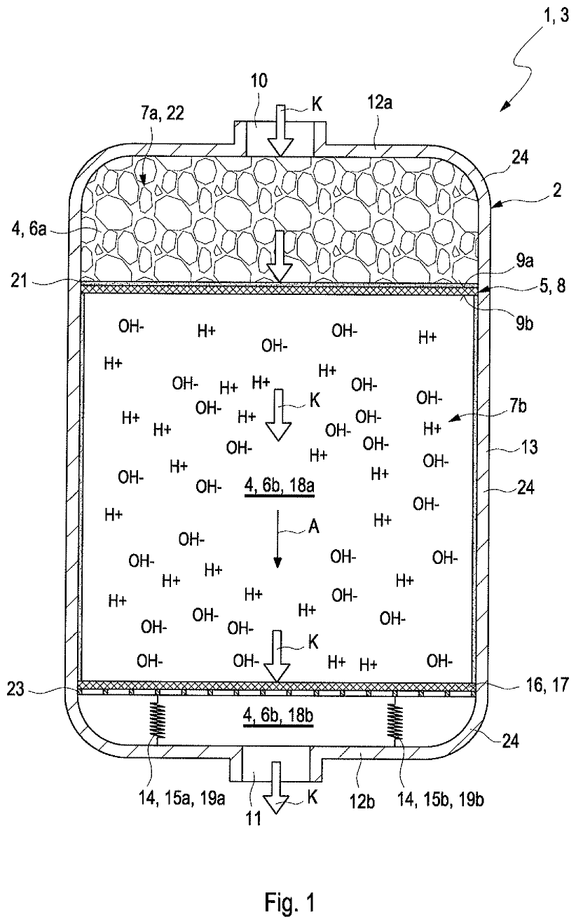

The sole FIG. 1 illustrates the setup of a filter device 1 according to the invention for cleaning coolant water K for an internal combustion engine in a schematic manner. The filter device 1 can be formed as exchangeable filter cartridge 3. The filter device 1 comprises a filter housing 2, which delimits a housing interior space 4, through which the coolant water can flow. An untreated water inlet 10 for introducing the coolant water K to be cleaned into the housing interior space 4 as well as a clean water outlet 11 for discharging the cleaned coolant water K is present in the filter housing 2. The untreated water inlet 10 and the clean water outlet 11 are preferably arranged in front side housing walls 12a, 12b of the filter housing 2, which are located opposite one another along an axial direction A. That front side housing wall 12a, in which the untreated water inlet 10 is arranged, will be referred to hereinafter as “inlet-side housing wall”. Accordingly, that front side housing wall 12b, in which the clean water outlet 11 is arranged, will be referred to hereinafter as “outlet side housing wall”. The two front side housing walls 12a, 12b are connected to one another via a circumferential wall 13, which is likewise part of the filter housing 2. In particular in the case that the filter device 1 is formed as filter cartridge 3, the filter housing 2 can be formed in one piece with the front side housing walls 12a, 12b and the circumferential wall 13.

According to FIG. 1, a water-permeable separating device 5, which divides the housing interior space 4 into a first filtration zone 6a and into a second filtration zone 6b, is arranged in the housing interior space 4. A first packing material 7a containing activated charcoal 22 for removing dirt particles (not shown) from the coolant water K is arranged in the first filtration zone 6a. A second packing material 7b, which contains hydronium cations (H⁺) and hydroxide (OH⁻) anions for demineralizing the coolant water K, is arranged in the second filtration zone.

The separating device 5 comprises or is a non-woven material 8, which is formed to be water-permeable and impermeable for the two packing materials 7a, 7b. It is ensured in this way that when the coolant water K flows through the housing interior space 4, the first packing material 7a always remains in the first filtration zone 6a, and the second packing material 7b always remains in the second filtration zone 6b.

In the example scenario, the inlet-side housing wall 12a, together with the circumferential wall 13 and the separating device 5 or the non-woven material 8, respectively, delimits the first filtration zone 6a. Analogously, the outlet-side housing wall 12b, together with the circumferential wall 13 and the separating device 5 or the non-woven material 8, respectively, delimits the second filtration zone 6b. The untreated water inlet 10 is thus arranged upstream of the first filtration zone 6a, which, in turn, is arranged upstream of the second filtration zone 6b. The second filtration zone 6b is arranged upstream of the clean water outlet 11. The coolant water K to be cleaned is thus introduced into the first filtration stage 6a via the untreated water inlet 10, flows through the separating device 5 or the non-woven material 8, respectively, into the second filtration zone 6b along the axial direction A, and leaves the housing interior space 4 from there via the clean water outlet 11.

According to FIG. 1, a biasing means 14, which biases the second packing material 7b towards the separating device, can be arranged in the housing interior space 4. Advantageously, this biasing means 14 is arranged between the clean water outlet 11 and the separating device 5 in the second filtration zone of the housing interior space 4. The separating device 5 can be attached to the filter housing 2 so as to be adjustable along the axial direction A, so that the biasing means 14 biases the first packing material 7a by means of the second packing material 7b and the separating device 5 against the inlet-side housing wall 12a of the filter housing 2. In the example scenario, the biasing means 14 comprises two spring-elastic elements 15a, 15b, which are arranged at a distance from one another and at which a water-permeable non-woven material 16, which is impermeable for the second packing material 7b, is arranged. The two spring-elastic elements 15a, 15b can be compression springs 19a, 19b, which are each supported on the outlet-side housing wall 12b at one end, and on the support structure 23 at the other end. In variations of the example, the biasing means 14 can have a different number of spring elements 15a, 15b than is shown in FIG. 1 in an exemplary manner. The non-woven material 16 divides the second filtration zone 6b into an untreated side 18a and into a clean side 18b. Instead of the non-woven material 16, a filter paper (not shown) can also be used. The flexibly formed non-woven material 16 or the flexibly formed filter paper 17, respectively, can be arranged on a mechanically stiff support structure 23, which is only arranged schematically in FIG. 1. The support structure 23 can preferably be formed in a mesh-like manner, so that the coolant water K can flow through the support structure 23 with a small flow resistance.

The material 24 of the filter housing 2 can consist of an extrudable granulate, which is equipped to be antibacterial, or can comprise an antibacterial granulate of this type, in particular in the area of the circumferential wall 13. In the alternative or in addition, the filter housing 2 can have an antibacterial coating 20 on the inner side at least in the area of the circumferential wall 13. This antibacterial coating 20 can comprise, for example, an organic monomer, oligomer, polymer, metals, and metal salts, or further substances comprising antibacterial properties.

The non-woven material 8 of the separating device 5 can also have an antibacterial coating 21, whereby above-listed materials are possible as coating materials. In the example of FIG. 1, the coating 21 is arranged on a side 9a of the separating device 5 or of the non-woven material 8, respectively, facing the first filtration side 6a. It goes without saying that in the alternative or in addition, the coating 21 can also be arranged on a side 9b of the separating device 5 or of the non-woven material 8, respectively, facing the second filtration zone 6b (not shown). It is also conceivable to equip the non-woven material 8 with antibacterial material, for example with silver, instead of an antibacterial coating 21.

1. A filter device for cleaning coolant water for an internal combustion engine, comprising:
a filter housing defining a housing interior space through which coolant water can flow, and an untreated water inlet and a clean water outlet arranged in the filter housing,
a water-permeable separating device that divides the housing interior space into a first filtration zone and into a second filtration zone,
a first packing material containing activated charcoal for removing dirt particles from the coolant water present in the first filtration zone, and a second packing material containing hydronium cations and hydroxide anions for demineralizing the coolant water present in the second filtration zone.

2. The filter device according to claim 1, wherein the water-permeable separating device comprises a water-permeable non-woven material that is impermeable for the first packing material and the second packing material.

3. The filter device according to claim 1, further comprising a biasing mechanism provided in the housing interior space, structured and arranged to bias the second packing material towards the water-permeable separating device.

4. The filter device according to claim 3, wherein the water-permeable separating device is adjustably attached to the filter housing, so that the biasing mechanism biases the first packing material via the second packing material and the water-permeable separating device against an inlet-side housing wall of the filter housing, the inlet-side housing wall located opposite the biasing mechanism and at least partially delimits the first filtration zone.

5. The filter device according to claim 1, wherein the clean water outlet is arranged in an outlet-side housing wall of the filter housing that is located opposite to an inlet-side housing wall and at least partially delimits the second filtration zone.

6. The filter device according to claim 3, wherein the biasing mechanism is arranged in the housing interior space between the clean water outlet and the water-permeable separating device.

7. The filter device according to claim 3, wherein the biasing mechanism includes at least one spring-elastic element, at which a non-woven material or filter paper is arranged that is water-permeable and impermeable for the second packing material and divides the second filtration zone into an untreated side and a clean side.

8. The filter device according to claim 7, wherein the non-woven material or the filter paper is arranged on a mechanically stiff support structure.

9. The filter device according to claim 7, wherein the at least one spring-elastic element includes a compression spring that is supported on an outlet-side housing wall at one end and on the water-permeable support structure at the other end.

10. The filter device according to claim 5, wherein the filter housing includes a circumferential wall that connects the inlet-side housing wall to the outlet-side housing wall, and wherein the filter housing has an antibacterial coating on an inner side at least in an area of the circumferential wall.

11. The filter device according to claim 10, wherein the antibacterial coating comprises a polymer provided with an antibacterial material.

12. The filter device according to claim 1, wherein the water-permeable separating device is composed of a non-woven that has an antibacterial coating.

13. The filter device according to claim 2, wherein the water-permeable separating device comprises an antibacterial coating including at least one of a metal, a metal salt, organic monomers, oligomers, and polymers, each comprising antibacterial properties.

14. The filter device according to claim 1, wherein the filter housing is composed of a material including a granulate configured to be antibacterial.

15. An internal combustion engine, comprising:
cylinders having combustion chambers,
a filter device for cooling the combustion chambers, the filter device including:
a filter housing defining a housing interior space through which coolant water can flow, and an untreated water inlet and a clean water outlet arranged in the filter housing,
a water-permeable separating device that divides the housing interior space into a first filtration zone and into a second filtration zone,
a first packing material containing activated charcoal for removing dirt particles from the coolant water present in the first filtration zone, and a second packing material containing hydronium cations and hydroxide anions for demineralizing the coolant water present in the second filtration zone.

16. The internal combustion engine according to claim 15, wherein the water-permeable separating device comprises a water-permeable non-woven plastic material that is impermeable for the first packing materials and the second packing material.

17. The internal combustion engine according to claim 15, wherein the filter device further includes a biasing mechanism provided in the housing interior space, structured and arranged to bias the second packing material towards the water-permeable separating device.

18. The internal combustion engine according to claim 17, wherein the biasing mechanism is arranged in the second filtration zone between the clean water outlet and the water-permeable separating device.

19. The internal combustion engine according to claim 18, wherein the water-permeable separating device is adjustably attached to the filter housing, so that the biasing mechanism biases the first packing material via the second packing material and the water-permeable separating device against an inlet-side housing wall of the filter housing, the inlet-side housing wall located opposite the biasing mechanism and at least partially delimits the first filtration zone.

20. The internal combustion engine according to claim 19, wherein the clean water outlet is arranged in an outlet-side housing wall of the filter housing that is located opposite to the inlet-side housing wall and at least partially delimits the second filtration zone.
